(19) United States
(12) Patent Application Publication
(10) Pub. No.: US 2023/0332053 A1
(43) Pub. Date: Oct. 19, 2023

(54) Absorbent Hygiene Product Comprising Recycled Material Made From Used Absorbent Hygiene Product Using Hydrothermal Treatment

(71) Applicant: The Procter & Gamble Company, Cincinnati, OH (US)

(72) Inventors: Dimitris Ioannis Collias, Mason, OH (US); Rodrigo Rosati, Frankfurt Am Main (DE)

(21) Appl. No.: 18/128,259

(22) Filed: Mar. 30, 2023

Related U.S. Application Data
(60) Provisional application No. 63/330,378, filed on Apr. 13, 2022.

(51) Int. Cl. C10G 1/04

(52) U.S. Cl. CPC C10G 1/047; C10G 2300/1003; C10G 2300/301; C10G 2300/305; C10G 2300/308; C10G 2300/4006; C10G 2300/4012; C10G 2400/20; C10G 2400/30

(57) ABSTRACT

Used AHP or its components is converted into a stream comprising low molecular weight n-paraffins, iso-paraffins, naphthenes, olefins, and aromatics using an HTT reactor. These low molecular weight hydrocarbons produce ethylene, propylene, and other chemicals when fed into a steam cracker, which can be used to produce polyethylene, polypropylene, and SAP recycled components of the AHP or a fully recycled AHP.

### FIELD OF THE INVENTION

The present invention generally relates to an absorbent hygiene product (AHP) comprising recycled materials made from used AHP (or its components) using hydrothermal treatment (HTT). Typical major components of an AHP are: superabsorbent polymer (SAP) used to absorb fluids and made from poly(acrylic acid) which in tum is made from propylene; backsheet film used to enclose the AHP and made from polyethylene (PE); and non-woven used to provide structure and made from polypropylene (PP). Other components are adhesives, elastics, polyester, and cellulose fibers. More specifically, a used AHP (optionally blended with mixed plastic waste) is fed into an HTT reactor, where the temperature and pressure are such that the water (either from the moisture associated with the used AHP, or from water added in the used AHP stream, or from water added in the HTT reactor) is converted into higher temperature and pressure water. In the conditions of the HTT reactor, the water degrades the used AHP and produces a liquid product stream. The liquid product stream comprises essentially low molecular weight hydrocarbons (i.e., C₆+; waste-derived fuel products), such as n-paraffins, iso-paraffins, cycloalkanes (naphthenes), olefins, aromatics, or mixtures thereof, and has properties (e.g., viscosity, vapor pressure, sulfur content, aromaticity, hydrogen content, oxygen content, calorific value, etc.) which resemble those of naphtha, diesel, gasoline, or other fuels. The liquid product stream is then fed into a steam cracker to produce ethylene, propylene, and other chemicals. The ethylene is then used to make PE for the backsheet film, and the propylene is used to make PP for the non-woven and poly(acrylic acid)-based SAP, thus producing an AHP with recycled materials from used AHPs.

### BACKGROUND OF THE INVENTION

Recycling of AHPs (i.e., baby diapers, feminine-protection pads, and adult incontinence pads) is good for the environment and needed to achieve the sustainability goals of many consumer companies. These goals are about using 100% recycled materials and having zero consumer and manufacturing waste go to landfill. In addition to these goals, successful recycling benefits the environment, stimulates the economy, improves people’s health and water quality, and generates energy needed by consumers in developing regions of the world.

The materials of AHPs are typically SAP, PE, PP, polyester, adhesives, elastics, and cellulose fibers. SAP is a water-absorbing, water-swellable, and water-insoluble powdered solid which is a crosslinked and partially neutralized homopolymer of glacial acrylic acid. SAP has an exceptionally high ability to absorb aqueous liquids, such as contaminated water or urine. PP is typically a large component of the non-woven component, PE is typically a large component of the backsheet film, and propylene is the typical feed material used to produce the SAP of an AHP.

Recycling of used AHPs involves cleaning of the AHPs from the soils accumulated during their use and separating the various materials into recycled material streams, such as cellulose stream, plastic stream, and SAP stream. Non-limiting examples of processes that produce purified and separated material streams of used SAP from recycled AHPs are disclosed and claimed in U.S. Pat. Nos 9,095,853 and 9,156,034; both assigned to Fater S.p.A, based in Pescara, Italy. A known limitation is that the streams of recovered cellulose, plastic and SAP, produced via mechanical separation methods, are of lower quality and contain contaminants, therefore making their use back into new AHPs difficult. For the purpose of recycling used AHPs into building blocks for the chemical industry, such as naphtha, one could consider pyrolysis, which is well known for converting mixed plastic waste into pyrolysis oil to be used along with virgin fossil naphtha in steam crackers; however, used AHPs contain significant amount of oxygen (e.g., in SAP, polyester, and cellulose) and pyrolysis is well known to be limited to handle only hydrocarbon polymers. Oxygenated polymers would significantly reduce the yield of pyrolysis oil, hinder the quality of the pyrolysis oil, and increase the yield of gases.

Accordingly, there is a need to recycle used AHPs: 1) in single stream of 100% AHPs or blended with mixed plastic waste at various ratios, 2) without separating the used AHPs into their material streams (e.g., plastic, SAP, and cellulose), and 3) with the use of energy-efficient methods that produce a single liquid product stream. There is the additional need for this liquid product stream from used AHPs to be suitable for feeding into typical chemical industry unit operations without cumbersome additional treatment (e.g., steam cracker) to produce feedstock chemicals for the various materials of AHPs, thus fully recycling used AHPs into new AHPs. Alternatively, the feedstock chemicals can be used to produce recycled materials for other applications in upcycling or downcycling operations.

### SUMMARY OF THE INVENTION

In embodiments of the present invention, an Absorbent Hygiene Product (AHP) is presented. The AHP comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; wherein said used AHP stream is fed into a hydrothermal treatment (HTT) reactor operating at an HTT reactor temperature, at an HTT reactor pressure, and for an HTT reactor residence time; wherein said HTT reactor produces a liquid product stream, a gas product stream, and a solid product; wherein said liquid product stream comprises waste-derived fuel products; and wherein said waste-derived fuel products are converted to at least one of said PP, said PE, and said SAP.

In embodiments of the present invention, an Absorbent Hygiene Product (AHP) is presented. The AHP comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; wherein said used AHP is size reduced to pieces; wherein said pieces have an average size between about 0.1 mm and about 10 cm; wherein said used AHP stream is fed into an extruder to produce a melt stream; wherein said melt stream is contacted with an aqueous solution to produce a mixed stream; wherein said mixed stream is fed into an HTT reactor operating at about 445° C., about 23 MPa, and for an HTT reactor residence time; wherein said HTT reactor produces a liquid product stream, a gas product stream, and a solid product; wherein said liquid product stream comprises waste-derived fuel products; wherein said waste-derived fuel products comprise n-paraffins, iso-paraffins, naphthenes, olefins, aromatics, or mixtures thereof; wherein said n-paraffins and said iso-paraffins comprise about 48% of said waste-derived fuel products, said naphthenes comprise about 15% of said waste-derived fuel products, said olefins comprise about 18% of said waste-derived fuel products, and said aromatics comprise about 10% of said waste-derived fuel products; wherein waste-derived fuel products comprise less than about 100 ppm nitrogen, less than about 100 ppm oxygen, less than about 5 ppm chlorine, less than about 0.001 ppm iron, less than about 0.125 ppm sodium, and less than about 0.5 ppm calcium; wherein said waste-derived fuel products are fed into a steam cracker; wherein said steam cracker produces a product stream comprising ethylene and propylene; wherein said ethylene is converted to said PE; wherein part of said propylene is converted to said PP; and wherein part of said propylene is converted to said SAP.

A method of producing an Absorbent Hygiene Product (AHP) is provided that comprises providing a used AHP stream comprising a used AHP; feeding said used AHP stream into a hydrothermal treatment (HTT) reactor operating at an HTT reactor temperature, at an HTT reactor pressure, and for an HTT reactor residence time; wherein said HTT reactor produces a liquid product stream, a gas product stream, and a solid product; wherein said liquid product stream comprises waste-derived fuel products; converting said waste-derived fuel products to at least one of PP, PE, and SAP; forming said AHP, wherein said AHP comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from the used AHP stream.

A material used to produce an AHP is provided that comprises at least one of polypropylene (PP), polyethylene (PE), or superabsorbent polymer (SAP); wherein at least one of said PP, PE, or SAP are produced from a used AHP stream comprising a used AHP; wherein said used AHP stream is fed into a hydrothermal treatment (HTT) reactor operating at an HTT reactor temperature, at an HTT reactor pressure, and for an HTT reactor residence time; wherein said HTT reactor produces a liquid product stream, a gas product stream, and a solid product; wherein said liquid product stream comprises waste-derived fuel products; and wherein said waste-derived fuel products are converted to at least one of said PP, said PE, and said SAP; and wherein said AHP comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene, wherein at least one of said PP, said PE, and said SAP are produced from the used AHP stream.

### DETAILED DESCRIPTION OF THE INVENTION

### I Definitions

As used herein, the term “used AHP” refers to an AHP which has already been produced industrially and/or used commercially, for example, as a baby diaper, feminine-protection pad, adult incontinence pad, or other uses. As such, used AHP can be post-industrial recycled AHP (PIR AHP) or post-consumer recycled AHP (PCR AHP).

As used herein, the term “degradation” refers to conversion of a material to a product that comprises low molecular weight hydrocarbon, via mechanisms, such as partial de-polymerization, de-crosslinking, molecular backbone breaking, partial hydrogenation or any combination of the above actions. A non-limiting example of degradation is the conversion of plastic waste to a product containing naphtha and other low molecular weight hydrocarbons in a pyrolysis process. Optionally, the degradation process might include hydrothermal process or hydrogenation of the degradation products.

As used herein, the term “hydrothermal treatment (HTT)” refers to a process in which waste is converted into waste-derived fuel product in the presence of water and optionally catalysts at elevated temperatures, such as 250° C. to 500° C., and elevated pressures, such as 0.1 MPa to 30 MPa. Under these conditions, water can be in supercritical conditions if its temperature exceeds the critical temperature of water of 374° C. and its pressure exceeds the critical pressure of water of 22.064 MPa. Alternatively, if the water temperature or pressure are lower than the respective critical temperature and critical pressure then the water is in subcritical conditions.

As used herein, the term “waste-derived fuel product” refers to energy-containing materials derived from the processing of waste, such as biomass, plastic waste, etc. and comprising “low molecular weight hydrocarbons”. The waste-derived fuel product is not primarily produced from virgin fossil resources, such as crude oil, natural gas, coal, etc. Non-limiting examples of low molecular weight hydrocarbons are naphtha (typically, C₅ to C₉ hydrocarbons with atmospheric boiling points between about 30° C. and about 175° C. to 200° C.) and diesel (typically, C₉ to C₂₅ hydrocarbons with atmospheric boiling points between about 175° C. to 200° C. and about 350° C.).

As used herein, the term “SAP” refers to crosslinked, partially neutralized, and poly(acrylic acid)-based superabsorbent polymer. SAP examples are disclosed in U.S. Pat. Nos 8,383,746 and 9,822,203. Typically, SAP is capable of absorbing a 0.9% saline solution at 25° C. at least 10 times its dry weight. The typical absorption mechanism is osmotic pressure. SAP that absorbs water or aqueous solutions becomes a gel.

### II Feed Stream

Unexpectedly, it has been found that used AHPs (despite the fact that they contain oxygenated materials, such as SAP, polyester, and cellulose) fed into an HTT reactor operating at a temperature between about 250° C. and about 500° C., pressure between about 0.1 MPa and about 30 MPa, and residence time between about 5 min and 180 min produce a liquid product stream comprising low molecular weight hydrocarbons. This liquid product stream is similar in composition to liquid product streams produced when plastic waste is fed into the HTT reactor operated under the same conditions as in the case of used AHPs. More specifically, the liquid product stream comprises n-paraffins, iso-paraffins, naphthenes, olefins, aromatics, or mixtures thereof. The liquid product stream has high calorific value and can be subjected to additional treatment (such as hydrogen treatment) to remove unwanted compounds (such as nitrogen, oxygen, chlorine, iron, sodium, and calcium) and thus be suitable for feeding into typical processes of the chemical industry, such as a steam cracker.

Without wishing to be bound by any theory, applicants believe that the water in the HTT reactor (from the moisture of the used AHP, or water added to the used AHP before the reactor, or water added in the HTT reactor) causes degradation of the AHP materials and production of a liquid product stream, a gas product stream, and solid product. The liquid product stream comprises low-molecular weight hydrocarbons and has low content of undesired elements, such as oxygen, chlorine, nitrogen, sulfur. Also, the liquid product stream comprises fuel components, such as naphtha, diesel, gasoline, or other fuels. The liquid product stream may be also referred to as synthetic crude or syncrude.

In embodiments of the present invention, the used AHP comprises materials such as SAP, cellulose, PE, PP, polyester, and adhesive. The AHP may be designed with lower mass of oxygen-containing materials, for example the AHP may not contain cellulose and PET and contain PE and PP instead. In embodiments of the present invention, the used AHP comprises cross-linked cellulose. In embodiments of the present invention, the used AHP comprises less than about 20% cellulose. In embodiments of the present invention, the used AHP comprises less than about 15% cellulose. In embodiments of the present invention, the used AHP comprises more than about 20% SAP. In embodiments of the present invention, the used AHP comprises more than about 30% SAP.

In embodiments of the present invention, an AHP comprises a non-woven, a backsheet film, and an SAP. In embodiments of the present invention, an AHP comprises a non-woven, a backsheet film, and an SAP; wherein said non-woven comprises PP; wherein said backsheet film comprises PE; and wherein said SAP comprises poly(acrylic acid) produced from propylene.

The used AHP stream is fed into the HTT reactor. In embodiments of the present invention, said used AHP stream comprises a used AHP. In embodiments of the present invention, the used AHP comprises about 60% moisture. In embodiments of the present invention, the used AHP comprises moisture between about 5% and about 90%. In embodiments of the present invention, the used AHP comprises moisture between about 10% and about 80%. In embodiments of the present invention, the used AHP comprises moisture between about 20% and about 50%. This moisture can be part of the urine or other body exudates in the used AHP, preferably inside the SAP, thus favoring an intimate contact between water and SAP for a faster reaction in the HTT reactor.

In embodiments of the present invention, the used AHP stream comprises an aqueous solution. In embodiments of the present invention, said aqueous solution is in supercritical conditions. In embodiments of the present invention, the used AHP stream comprises water. The water in the used AHP stream can be RO water, regular tap water, or water containing dissolved inorganic salts at various salt concentrations. The used AHP stream may contain significant amounts of water. The water removed from the used AHP prior to the feeding of the used AHP to the extruder prior to the HTT reactor may be recycled to prepare the aqueous solution. In embodiments of the present invention, the process may not require use of virgin water, as it may recycle the water recovered from the incoming used AHP stream; alternatively, the recovered water, from the used AHP stream, may cover at least about 50% of the water needs of the process.

In embodiments of the present invention, the used AHP stream comprises between about 20% and about 90% said used AHP on a dry basis and between about 10% and about 80% said aqueous solution. In embodiments of the present invention, the used AHP stream comprises between about 40% and about 80% said used AHP on a dry basis and between about 20% and about 60% said aqueous solution.

The used AHP may also be dried, prior to being fed into the HTT reactor, to adjust its water content. More specifically, the used AHP stream may be dried to water content of less than 100%, more preferably less than about 20%, and most preferably less than about 5%, prior to being fed into the HTT reactor.

The used AHP may be dried and reduced to pellets with methods known in the art, such the SFD system, commercially available from Super Faiths Inc. Alternatively, after been dried, the used AHP may be mixed and compounded with other plastic waste and reduced into pellets to be fed into the HTT reactor.

In embodiments of the present invention, said used AHP is size reduced to pieces. The size reduction can be of any type known to those skilled in the art. In embodiments of the present invention, said size reduction is selected from the group comprising grinding, chipping, pelletization, granulation, flaking, powdering, shredding, milling, or compression and expansion. In embodiments of the present invention, the used AHP pieces have an average size. In embodiments of the present invention, the average size of the pieces of the used AHP is between about 0.1 mm and about 10 cm. In embodiments of the present invention, the average size of the pieces of the used AHP is between about 1 mm and about 8 cm. In embodiments of the present invention, the average size of the pieces of the used AHP is between about 1 cm and about 6 cm. In embodiments of the present invention, the average size of the pieces of the used AHP is between about 1.5 cm and about 5 cm. Furthermore, the size reduction method can be followed by a method to remove materials, such as halogen.

In embodiments of the present invention, said used AHP is size reduced to pieces; wherein said pieces are fed into an extruder to produce a melt stream; and wherein said melt stream is contacted with an aqueous solution to produce said used AHP stream. In embodiments of the present invention, said used AHP stream comprises about 25% said used AHP on a dry basis and about 75% mixed plastic waste on a dry basis. In embodiments of the present invention, said used AHP stream comprises between about 5% and about 40% said used AHP on a dry basis and between about 60% and about 95% mixed plastic waste on a dry basis. In embodiments of the present invention, said used AHP stream comprises about 100% said used AHP on a dry basis. In embodiments of the present invention, said used AHP stream comprises between about 10% and about 30% said used AHP on a dry basis and between about 70% and about 90% mixed plastic waste on a dry basis.

In embodiments of the present invention, said used AHP stream comprises said used AHP, a mixed plastic waste, and an aqueous solution. In embodiments of the present invention, said used AHP stream comprises between about 5% and about 25% used AHP on a dry basis, between about 35% and about 75% mixed plastic waste on a dry basis, and between about 20% and about

70% said aqueous solution. In embodiments of the present invention, said used AHP stream comprises between about 10% and about 20% used AHP on a dry basis, between about 40% and about 70% mixed plastic waste on a dry basis, and between about 30% and about 50% said aqueous solution.

The used AHP stream may be 100% of used AHP or may also contain other waste materials, such as plastic waste, agricultural waste, food waste, mixed waste, depending on considerations like logistics of waste collection. The used AHP stream may be made of the dried used AHP and mixed plastic waste.

The melt stream may exit from the extruder at a pressure between about 2 MPa and about 30 MPa and a temperature between about 200° C. and about 380° C. The melt stream may be mixed with the aqueous solution in a mixer to form a mixed stream; the aqueous solution, may be preheated to supercritical conditions in heaters prior to the mixer. The mixed stream may be further heated with heaters prior to being fed into the HTT reactor. The extruder may be directly connected to the HTT reactor in a manner allowing the mixed stream to flow into the HTT reactor in a continuous flow. In embodiments of the present invention, the mixed stream comprises between about 30% and about 80% used AHP on a dry basis, and between about 20% and about 70% aqueous solution. In embodiments of the present invention, the mixed stream comprises between about 30% and about 80% used AHP and plastic waste on a dry basis, and between about 20% and about 70% aqueous solution, wherein the used AHP and plastic waste composition may be on a dry basis between about 1% of used AHP to about 100% of used AHP, between about 5% of used AHP to about 50% of used AHP. A molar ratio of hydrogen to carbon (H/C) of used AHP and plastic waste composition may be greater than about 2.15, greater than about 1.2, greater than about 1.0, or greater than about 0.8. The aqueous solution may be supercritical prior to said contacting. The aqueous solution may be subcritical prior to said contacting.

If the stream of aqueous solution is not provided, because for example the aqueous solvent is water and there is already enough water in the used AHP, the water may be brought to supercritical conditions in the extruder, prior to being fed into the HTT reactor, or in the HTT reactor.

In embodiments of the present invention, the aqueous solution comprises between about 5% and about 40% alcohol. In embodiments of the present invention, the aqueous solution comprises between about 5% and about 40% alcohol, wherein said alcohol is selected from the group consisting of methanol, ethanol, iso-propyl alcohol, iso-butyl alcohol, pentyl alcohol, hexanol, iso-hexanol, or any combination thereof. Without wishing to be bound by any theory, it is believed that the use of alcohol may be beneficial to control the swelling level of the SAP, contained in the used AHP. In embodiments of the present invention, the mixed stream comprises a catalyst selected from the group consisting of base catalyst, acid catalyst, water-gas-shift reaction catalyst, aluminosilicate catalyst, sulphide catalyst, or any combination thereof. The catalyst may be added to the mixed stream after the mixed stream has reached the HTT reactor temperature, or after the mixed stream has reached the HTT reactor temperature and the HTT reactor pressure. In addition, intrinsic catalysts may be present in the AHP, or in the vessel walls of the HTT reactor. In embodiments of the present invention, no catalyst is used. The mixed stream may comprise between about 5% and about 60% of oil, optionally wherein the oil is recycled from a waste-derived-oil product previously generated in accordance with the method above. The oil may be paraffinic oil, gas-oil, crude oil, synthetic oil, coal-oil, bio-oil, shale oil, kerogen oil, mineral oil, white mineral oil, and aromatic oil.

The mixed stream may contain a solid substrate component, such as coal, coke, tar, char, ash, and mineral. Alternatively, fillers, already intrinsically present in the used AHP, such as calcium carbonate, zeolites, etc. may avoid the use of a solid substrate component.

In embodiments of the present invention, the used AHP is dried prior to its size reduction. In embodiments of the present invention, the dried used AHP has moisture between about 5% and about 50%. In embodiments of the present invention, the dried used AHP has moisture between about 10% and about 30%.

### III HTT Reactor

The HTT reactor can be of any type known to those skilled in the art. A non-limiting example of an HTT reactor is an autoclave. The degradation of a used AHP can be catalytic or non-catalytic, and can proceed in continuous, batch, or semi batch modes. The metal or alloy of construction of the HTT reactor can be stainless steel, carbon steel, or any other suitable metal or alloy. The HTT reactor apparatus may include a blow down valve for the removal of undesirable solids, such as coke, char, precipitated metal halides, calcium carbonate fillers, inorganic salts, metal or inorganic contamination of the feed materials, etc. The addition of a base to the melt stream, to the feed materials or mixed stream or reaction mixture may facilitate the formation of solids to be collected from the bottom of the HTT reactor. The HTT reactor may contain various zones with different temperatures, pressures, and residence times to degrade the various AHP components at specific conditions.

The degradation of the used AHPs may be carried out at any suitable temperature and pressure, which is measured in the HTT reactor. Without wishing to be bound by any theory, it is believed that the use of supercritical or subcritical water enables better heat exchange into the AHP, which may otherwise cause inefficient conversion of the used AHP and formation of char.

In embodiments of the present invention, the HTT reactor temperature is between about 250° C. and about 500° C. In embodiments of the present invention, the HTT reactor temperature is about 445° C. In embodiments of the present invention, the HTT reactor temperature is higher than about 300° C. In embodiments of the present invention, the HTT reactor temperature is higher than about 350° C. In embodiments of the present invention, the HTT reactor temperature is higher than about 400° C. In embodiments of the present invention, the HTT reactor temperature is between about 425° C. and about 500° C.

In embodiments of the present invention, the HTT reactor pressure is between about 0.1 MPa and about 30 MPa. In embodiments of the present invention, the HTT reactor pressure is between about 0.2 MPa and about 25 MPa. In embodiments of the present invention, the HTT reactor pressure is between about 1 MPa and about 20 MPa. In embodiments of the present invention, the HTT reactor pressure is higher than about 0.2 MPa. In embodiments of the present invention, the HTT reactor pressure is higher than about 1 MPa. In embodiments of the present invention, the HTT reactor pressure is higher than about 3 MPa. In embodiments of the present invention, the HTT reactor pressure is higher than about 10 MPa. In embodiments of the present invention, the HTT reactor pressure is higher than about 23 MPa. In embodiments of the present invention, the HTT reactor pressure is about 0.25 MPa. In embodiments of the present invention, the HTT reactor pressure is about 1.5 MPa. In embodiments of the present invention, the HTT reactor pressure is about 3.8 MPa. In embodiments of the present invention, the HTT reactor pressure is about 23 MPa.

In embodiments of the present invention, the HTT reactor temperature is higher than about 400° C. and the HTT reactor pressure is higher than about 10 MPa. In embodiments of the present invention, the HTT reactor temperature is about 450° C. and the HTT reactor pressure is higher than about 0.25 MPa. In embodiments of the present invention, the HTT reactor temperature is about 450° C. and the HTT reactor pressure is higher than about 1.5 MPa. In embodiments of the present invention, the HTT reactor temperature is about 450° C. and the HTT reactor pressure is higher than about 3.8 MPa. In embodiments of the present invention, the HTT reactor temperature is about 450° C. and the HTT reactor pressure is higher than about 10 MPa. In embodiments of the present invention, the HTT reactor temperature is about 445° C. and the HTT reactor pressure is about 23 MPa.

The HTT reactor residence time is defined as the average time the feed material spends in the HTT reactor, and its value can be of any suitable amount. In embodiments of the present invention, the HTT reactor residence time is longer than about 5 min. In embodiments of the present invention, the HTT reactor residence time is longer than about 10 min. In embodiments of the present invention, the HTT reactor residence time is longer than about 30 min. In embodiments of the present invention, the HTT reactor residence time is longer than about 45 min. In embodiments of the present invention, the HTT reactor residence time is longer than about 60 min. In embodiments of the present invention, the HTT reactor residence time is longer than about 90 min. In embodiments of the present invention, the HTT reactor residence time is longer than about 120 min. In embodiments of the present invention, the HTT reactor residence time is longer than about 150 min. In embodiments of the present invention, the HTT reactor residence time is between about 20 min and about 180 min. In embodiments of the present invention, the HTT reactor residence time is between about 30 min and about 150 min. In embodiments of the present invention, the HTT reactor residence time is between about 40 min and about 80 min. The residence time in the HTT reactor may be achieved via an array of multiple connected HTT reactors in series.

In embodiments of the present invention, an Absorbent Hygiene Product (AHP) comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; and wherein said used AHP stream is fed into a hydrothermal treatment (HTT) reactor operating at an HTT reactor temperature, at an HTT reactor pressure, and for an HTT reactor residence time.

In embodiments of the present invention, an Absorbent Hygiene Product (AHP) comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; wherein said used AHP is size reduced to pieces; wherein said pieces have an average size between about 0.1 mm and about 10 cm; wherein said used AHP stream is fed into an extruder to produce a melt stream; wherein said melt stream is contacted with an aqueous solution to produce a mixed stream; and wherein said mixed stream is fed into an HTT reactor operating at about 445° C., about 23 MPa, and for an HTT reactor residence time.

### IV Product Stream

In embodiments of the present invention, the HTT reactor produces a product stream comprising a gas product stream, a liquid product stream, and a solid product. Typically, the gas product stream comprises hydrocarbons with C₅ and lower carbon chain lengths, although some small amounts of C₆ and above may also be present. Typically, the liquid product stream comprises hydrocarbons with C₆ up to C₃₁ carbon chain lengths, although some small amount of C₅ and above may also be present. In embodiments of the present invention, the gas product stream is between about 5% and about 50% of the product stream or between about 5% and about 30% of the product stream. In embodiments of the present invention, the liquid product stream is between about 50% and about 90% of the product stream or between about 70% and about 85% of the product stream. In embodiments of the present invention, the solid product is about 10% or less of the product stream or about 5% or less of the product stream. In embodiments of the present invention, the liquid product stream is about 75% of the product stream, the gas product stream is about 20% of the product stream, and the solid product about 5% of the product stream. In embodiments of the present invention, the liquid product stream is about 83% of the product stream, the gas product stream is about 15% of the product stream, and the solid product about 2% of the product stream. In embodiments of the present invention the solid product stream is very small, e.g. below 2%, effectively there are only two product streams, a gas product stream and a liquid hydrocarbon mix product stream, which contains the liquid product stream and the small solid product stream: the liquid hydrocarbon mix product stream is about 85% of the product stream, the gas product stream is about 15% of the product stream.

In embodiments of the present invention, the liquid product stream is more than about 30% of the product stream on a dry basis. In embodiments of the present invention, the liquid product stream is more than about 50% of the product stream on a dry basis. In embodiments of the present invention, the liquid product stream is more than about 60% of the product stream on a dry basis. In embodiments of the present invention, the liquid product stream is more than about 70% of the product stream on a dry basis. In embodiments of the present invention, the liquid product stream is more than about 80% of the product stream on a dry basis. In embodiments of the present invention, the liquid product stream has a calorific value higher than about 30 MJ/kg. In embodiments of the present invention, the liquid product stream has a calorific value higher than about 40 MJ/kg. In embodiments of the present invention, the liquid product stream has a calorific value higher than about 45 MJ/kg.

In embodiments of the present invention, the liquid stream comprises nitrogen at a concentration of less than about 100 ppm. In embodiments of the present invention, the liquid product stream comprises oxygen at a concentration of less than about 100 ppm. In embodiments of the present invention, the liquid product stream comprises chlorine at a concentration of less than about 5 ppm. In embodiments of the present invention, the liquid product stream comprises chlorine at a concentration of less than about 3 ppm. In embodiments of the present invention, the liquid product stream comprises iron at a concentration of less than about 0.001 ppm. In embodiments of the present invention, the liquid product stream comprises sodium at a concentration of less than about 0.125 ppm. In embodiments of the present invention, the liquid product stream comprises calcium at a concentration of less than about 0.5 ppm.

In embodiments of the present invention, the liquid product stream is treated to produce a stream suitable for feeding into a stream cracker. In embodiments of the present invention, the liquid product stream is treated with hydrogen and contains nitrogen at a concentration of less than about 100 ppm, oxygen at a concentration of less than about 100 ppm, chlorine at a concentration of less than about 3 ppm, iron at a concentration of less than about 0.001 ppm, sodium at a concentration of less than about 0.125 ppm, and calcium at a concentration of less than about 0.5 ppm. In embodiments of the present invention, the liquid product stream is treated to produce a stream suitable for feeding into a stream cracker. In embodiments of the present invention, the liquid product stream is treated with hydrogen and contains nitrogen at a concentration of less than about 100 ppm, oxygen at a concentration of less than about 100 ppm, chlorine at a concentration of less than about 5 ppm, iron at a concentration of less than about 0.001 ppm, sodium at a concentration of less than about 0.125 ppm, and calcium at a concentration of less than about 0.5 ppm.

In embodiments of the present invention, the liquid product stream comprises a low molecular weight hydrocarbon. In embodiments of the present invention, the liquid product stream comprises waste-derived fuel products. In embodiments of the present invention, the liquid product stream comprises naphtha. In embodiments of the present invention, the liquid product stream comprises diesel. In embodiments of the present invention, the liquid product stream comprises gasoline.

The waste-derived fuel products may comprise multiple phases, including but not limited to a water-soluble aqueous phase and a water insoluble phase. The water-insoluble phase may also be called oil phase and comprises known fuel fractions, such as naphtha and diesel. The water soluble phase may comprise, compounds including, but not limited to, any one or more of carbohydrates, aldehydes, carboxylic acids, carbohydrates, phenols, furfurals, alkenes, alkanes, aromatic hydrocarbons, styrene, ethylbenzene, alcohols, and ketones, resins and resin acids, and compounds structurally related to resin acids, alkanes and alkenes, fatty acids and fatty acid esters, sterols and sterol-related compounds, furanic oligomers, cyclopentanones, and cyclohexanones, alkyl- and alkoxy-cyclopentanones, and cyclohexanones, cyclopentenones, alkyl- and alkoxy-cyclopentenones, aromatic compounds including naphthalenes and alkyl- and alkoxy-substituted naphthalenes, cresols, alkyl- and alkoxy-phenols, alkyl- and alkoxy-catechols, alkyl- and alkoxy-trihydroxybenzenes, alkyl- and alkoxy-hydroquinones, indenes and indene-derivatives. The water insoluble phase may comprise, compounds including, but not limited to, any one or more of alkenes, alkanes, aromatic hydrocarbons, styrene, ethylbenzene, waxes, aldehydes, carboxylic acids, carbohydrates, phenols, furfurals, alcohols, and ketones, resins and resin acids, and compounds structurally related to resin acids, alkanes and alkenes, fatty acids and fatty acid esters, sterols and sterol-related compounds, furanic oligomers, cyclopentanones, and cyclohexanones, alkyl- and alkoxy cyclopentanones, and cyclohexanones, cyclopentenones, alkyl- and alkoxy-cyclopentenones, aromatic compounds including naphthalenes and alkyl- and alkoxy-substituted naphthalenes, cresols, alkyl- and alkoxy-phenols, alkyl- and alkoxy-catechols, alkyl- and alkoxy-trihydroxybenzenes, alkyl- and alkoxy-hydroquinones, indenes and indene-derivatives. Exemplary compounds comprised in the water insoluble liquid phase are i-butane, butene-1, n-butane, isobutylene, t-butene-2, c-butene-2, i-pentane, pentene-1, 2-methylbutene-1, n-pentane, t-pentene-2, c-pentene-2, 2-methylbutene-2, cyclopentene, 4-methylpentene-1, cyclopentane, 2,3-dimethylbutene-1, 2-methylpentane, 3-methylpentane, 4-methyl-t-pentene-2, 2-methylpentene-1, hexene-1, n-hexane, t-hexene-3, c-hexene-3, t-hexene-2, 2-methylpentene-2, 3-methyl-c-pentene-2, 3-methylcyclopentene, c-hexene-2, 3,3-dimethylpentene-1, methylcyclopentane, 2,4-dimethylpentane, 2,3,3-trimethylbutene-1, 4,4-dimethyl-c-pentene-2, benzene, 2-methyl-c-hexene-3, 5-methylhexene-1, cyclohexane, 2-methyl-t-hexene-3, heptane-1, n-heptane, methylcyclohexane, toluene, 4-methylheptane, octene-1, n-octane, 3,5-dimethylheptane, ethylbenzene, 1c,2t,4t-trimethylcyclohexane, 1,3-dimethylbenzene, n-nonane, n-decane, n-undecane. A naphtha fraction may be separated from the liquid product stream, having boiling point below 175° C. The average molecular weight of the naphtha fraction may be between 90 and 220 g/mol, or between 100 and 130 g/mol. The relative density of the naphtha fraction may be between 0.65 and 0.8. The octane number of the naphtha fraction may be between 50 and 90. Other non-limiting examples of waste-derived fuel products include oil char (e.g., carbon char with bound oils), char, and gaseous product (e.g., methane, hydrogen, carbon monoxide and/or carbon dioxide, ethane, ethene, propene, propane).

In embodiments of the present invention, the waste-derived fuel products comprise n-paraffins, iso-paraffins, naphthenes, olefins, aromatics, or mixtures thereof. In embodiments of the present invention, said waste-derived products comprise naphtha. In embodiments of the present invention, the n-paraffins are between about 5% and about 40% of the liquid product stream. In embodiments of the present invention, the iso-paraffins are between about 4% and about 30% of the liquid product stream. In embodiments of the present invention, the naphthenes are between about 5% and about 30% of the liquid product stream. In embodiments of the present invention, the olefins are between about 5% and about 30% of the liquid product stream. In embodiments of the present invention, the aromatics are between about 5% and about 30% of the liquid product stream.

In embodiments of the present invention, the waste-derived fuel products comprise n-paraffins and iso-paraffins between about 20% and about 50%. In embodiments of the present invention, the waste-derived fuel products comprise naphthenes between about 10% and about 20%. In embodiments of the present invention, the waste-derived fuel products comprise olefins between about 10% and about 20%. In embodiments of the present invention, the waste-derived fuel products comprise aromatics between about 5% and about 20%. In embodiments of the present invention, the waste-derived fuel products comprise n-paraffins and iso-paraffins between about 20% and about 50%; naphthenes between about 10% and about 20%; olefins between about 10% and about 20%; and aromatics between about 5% and about 20%. In embodiments of the present invention, the waste-derived fuel products comprise n-paraffins and iso-paraffins about 48%; naphthenes about 15%; olefins about 18%; and aromatics about 10%.

In embodiments of the present invention, a method for recycling a used absorbent hygiene product (used AHP) comprises feeding said used AHP in a hydrothermal treatment (HTT) reactor at an HTT reactor temperature, at an HTT reactor pressure, and for an HTT reactor residence time; and wherein a liquid product stream from said HTT reactor comprises waste-derived fuel products.

In embodiments of the present invention, a method for recycling a used AHP comprises: 1) size reduction of the used AHP to pieces; 2) feeding the pieces to an extruder to produce a melt stream; 3) providing an aqueous solution; 4) contacting the melt stream with the aqueous solution to produce a mixed stream; 5) feeding the mixed stream in an HTT reactor at an HTT reactor temperature, at an HTT reactor pressure, and for an HTT reactor residence time; 6) producing a liquid product stream comprising waste-derived fuel products; and 7) depressurizing and cooling the liquid product stream.

In embodiments of the present invention, a method for recycling a used AHP comprises: 1) size reduction of the used AHP to pieces; 2) providing an aqueous solution; 3) contacting the AHP pieces with the aqueous solution to produce a mixed stream; 4) feeding the mixed stream in an HTT reactor at an HTT reactor temperature, at an HTT reactor pressure, and for an HTT reactor residence time; 5) producing a liquid product stream comprising waste-derived fuel products; and 6) depressurizing and cooling the liquid product stream.

One or more of the waste-derived fuel products may comprise less than about 10% oxygen, preferably less than about 5% oxygen, more preferably less than about 2% oxygen, even more preferably less than about 0.5% oxygen, and most preferably less than about 0.1% oxygen. Without wishing to be bound by any theory, it is believed that the use of water in the HTT reactor enables the reduction of the oxygen content in the liquid product stream. This is very important as AHPs may contain materials with significant oxygen content, such as polyester, SAP, cellulose, which would otherwise reduce the value of the waste-derived fuel products. The waste-derived fuel products may be further treated in order to reduce their oxygen content.

One or more of the waste-derived fuel products may contain less than about 5% nitrogen, preferably less than about 1% nitrogen, more preferably less than about 0.5% nitrogen, and most preferably less than about 0.1% nitrogen. Without wishing to be bound by any theory, it is believed that the use of water in the HTT reactor enables the reduction of the nitrogen content in the liquid product stream. This is very important as AHPs may contain significant nitrogen content, such as urea contained in the human exudates, which would otherwise reduce the value of the waste-derived fuel products. In addition reducing nitrogen content in one or more of the waste-derived fuel products may be achieved via removing, at least partly, urea contained in human exudates: this may be done for example subjecting the used AHP to a pre-treatment to de-swell the SAP, for example with a calcium compound or an organic acid solution as known in the art (U.S. Pat. No. 9,777,131; and U.S. Pat. Application US 2017/0107667), then removing the urea from the liquid phase with methods known in the art, such as those used in wastewater treatment, e.g. electrochemical oxidation, adsorption, biological treatment, hydrolysis. In addition, the diaper design may be made such as to reduce the content of nitrogen, for example replacing the polyurethane-based components, such as the elastics, with synthetic rubber-based components. The waste-derived fuel products may be further treated in order to reduce the nitrogen content.

One or more of the waste-derived fuel products may contain less than about 1% chlorine, preferably less than about 0.1% chlorine, more preferably less than about 0.01% chlorine, and most preferably less than about 0.005% chlorine. Used AHP may contain significant amount of chlorine due to the salts, such as sodium chlorides, contained in the human exudates. Without wishing to be bound by any theory, being salts, like sodium chlorides, water soluble, they may preferably partition into the water-soluble aqueous phase, hence yielding a water insoluble liquid phase with lesser chlorine content. In addition, the transfer of halogens, such as chlorine, present in the reaction mixture to the water-soluble aqueous phase as inorganic halides may reduce issues around dioxin formation. In addition reducing chlorine content in one or more of the waste-derived fuel products may be achieved via removing, at least partly, chlorides contained in human exudates absorbed in the AHPs: this may be done for example subjecting the used AHP to a pre-treatment to de-swell the SAP, for example with a calcium compound or an organic acid solution as known in the art (U.S. Pat. No. 9,777,131; and U.S. Pat. Application US 2017/0107667), then removing the chlorides from the water phase with methods known in the art, such as reverse osmosis, distillation or electro-dialysis. In addition, the diaper design may be made such as to reduce the content of chlorine, for example avoiding chlorine containing polymers and additives in the formulation of the AHP: as an example chlorine free pulp may be used. The waste-derived fuel products may be further treated in order to reduce the chlorine content.

One or more of the waste-derived fuel products may contain less than about 1% sulfur, preferably less than about 0.1% sulfur, more preferably less than about 0.01% sulfur, and most preferably less than about 0.005% sulfur. Used AHP may contain significant amount of sulfur due to sulfur containing compounds contained in the human exudates, for example sulfates, cystine. Without wishing to be bound by any theory, being these sulfur containing compounds water soluble, they may preferably partition into the water-soluble aqueous phase, hence yielding a water insoluble liquid phase with lesser sulfur content. In addition reducing sulfur content in one or more of the waste-derived fuel products may be achieved via removing, at least partly, sulfur compounds contained in the human exudates, absorbed by the AHPs: this may be done for example subjecting the used AHP to a pre-treatment to de-swell the SAP, for example with a calcium compound or an organic acid solution as known in the art (U.S. Pat. No. 9,777,131; and U.S. Pat. Application US 2017/0107667), then removing the sulfur compounds from the liquid phase with methods known in the art, such as reverse osmosis. In addition, the diaper design may be made such as to reduce the content of sulfur, for example avoiding sulfur containing polymers and additives in the formulation of the AHP. The waste-derived fuel products may be further treated in order to reduce the sulfur content.

After depressurizing and cooling the waste-derived fuel products, they may be subjected to further separation techniques to recover one or more of a gaseous, aqueous, oil, and/or wax component from the product, and/or separating one or more fractions of an oil, and/or one or more fractions of a wax component from the product. For example, upon depressurization and cooling the synthetic crude oil will separate from the water in the flash tank and float on the water, being of lower density than water. Gas and vapor will also be separated at this point. The gas will be calorific and can be combusted to provide energy to the process. The separation of the two liquid phases can be further improved by use of, for example, a centrifuge. The oil phase can be subjected to further processing, for example it can be distilled to provide fractions such as naphtha, middle distillates, heavy gas oils and vacuum gas oils, and waxes. Waxes and partly converted polymers may optionally be recycled as feed to the front of the process for further cracking. Naphtha and other fractions may optionally be added to the reaction mixture, for example by injection after the extruder barrel or after the mixing piece, to act as solvents to lower the fluid viscosity and modify the phase behavior.

Waste-derived fuel products can be separated and recycled into one or more fractions having a boiling point between about 30° C. and about 140° C., between about 60° C. and about 160° C., between about 140° C. and about 205° C., between about 150° C. and about 300° C., or between about 230° C. and about 350° C. For example, waste-derived fuel products can be separated and recycled into one or more fractions of the product comprising a wax or a waxy oil having a boiling point above 370° C. atmospheric equivalent boiling point (AEBP), above 400° C. AEBP, above 450° C. AEBP, above 500° C. AEBP, or above 550° C. AEBP.

An additional benefit of the present invention is the reduced formation of char, which is undesired as valuable carbon is subtracted from the more valuable water insoluble liquid phase, which comprises naphtha and diesel. Without wishing to be bound by any theory, it is believed that the use of water in an HTT reactor reduces the formation of char, in particular from cellulosic materials but also from synthetic polymer materials, contained in the AHP.

Further the method comprises separating and recycling a fraction of the waste-derived fuel products having a boiling point in the range of: naphtha boiling range, heavy naphtha boiling range, kerosene boiling range, diesel boiling range, heavy gas oil boiling range, or vacuum gas oil boiling range. Typically, the waste-derived fuel products have lower average molecular weight than the polymeric materials, comprised in the used AHP, prior to conversion. Further any of the fractions above may be combusted to provide heat for repeating the method.

In embodiments of the present invention, an Absorbent Hygiene Product (AHP) comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; wherein said used AHP stream is fed into a hydrothermal treatment (HTT) reactor operating at an HTT reactor temperature, at an HTT reactor pressure, and for an HTT reactor residence time; wherein said HTT reactor produces a liquid product stream, a gas product stream, and a solid product; and wherein said liquid product stream comprises waste-derived fuel products.

In embodiments of the present invention, an Absorbent Hygiene Product (AHP) comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; wherein said used AHP is size reduced to pieces; wherein said pieces have an average size between about 0.1 mm and about 10 cm; wherein said used AHP stream is fed into an extruder to produce a melt stream; wherein said melt stream is contacted with an aqueous solution to produce a mixed stream; wherein said mixed stream is fed into an HTT reactor operating at about 445° C., about 23 MPa, and for an HTT reactor residence time; wherein said HTT reactor produces a liquid product stream, a gas product stream, and a solid product; and wherein said liquid product stream comprises waste-derived fuel products; wherein said waste-derived fuel products comprise n-paraffins, iso-paraffins, naphthenes, olefins, aromatics, or mixtures thereof; wherein said n-paraffins and said iso-paraffins comprise about 48% of said waste-derived fuel products, said naphthenes comprise about 15% of said waste-derived fuel products, said olefins comprise about 18% of said waste-derived fuel products, and said aromatics comprise about 10% of said waste-derived fuel products; wherein waste-derived fuel products comprise less than about 100 ppm nitrogen, less than about 100 ppm oxygen, less than about 5 ppm chlorine, less than about 0.001 ppm iron, less than about 0.125 ppm sodium, and less than about 0.5 ppm calcium.

### V Recycled AHP

The liquid product stream can be fed into a steam cracker to produce ethylene, propylene, and other chemicals that can be used to produce polyethylene, polypropylene, polyester, adhesives, SAP, etc. which can form a recycled AHP. A waste-derived fuel product may be further processed to be made compatible with a cracker unit to obtain base monomers, such as ethylene and propylene, which may then be used to produce new polymers, such as polyethylene, polypropylene, polyacrylate, etc., which may be used to produce new diapers or other market products or packaging.

In embodiments of the present invention, the waste-derived fuel products are fed into a steam cracker; and wherein the steam cracker produces a product stream comprising ethylene and propylene. In embodiments of the present invention, the ethylene is converted to the PE, part of the propylene is converted to the PP, and part of the propylene is converted to the SAP.

In embodiments of the present invention, an absorbent hygiene product (AHP) comprises at least one component which has been produced from waste-derived fuel products, wherein the waste-derived fuel products have been produced from recycling a used AHP according to any of the embodiments above. In embodiments of the present invention, the AHP comprises at least one of the PE, the PP, and the SAP.

### EXAMPLE

The feedstock comprised 75% mixed plastic waste (rigid post-consumer; later referred to as PCPW) and 25% Pampers Baby Dry Size 5 diapers (referred to as diapers; produced in Germany in May 2021). PCPW comprised post-consumer packaging, such as shredded pots, tubs and trays, consisting mainly of polyethylene and polypropylene, with some residual contamination of organics, paper, card and non-polyolefin plastics. In this example, the diapers were dry virgin diapers, not used by consumers. The diapers contained about 3% of PET, about 45% of SAP and about 13% of cellulose, referred to the dry weight of the diaper: based on this, the diapers contained more than 20% of oxygen by weight, referred to the dry weight of the diapers. The diapers were crushed and pelletized using a pin mill grinding machine, then they were mixed with PCPW and homogenized with a cement mixer to create a mixed diaper-plastic feed (MDPF). Such MDPF had an ash content of about 4.3% (dry basis) and a water content of about 3%.

MDPF was fed into the extruder hopper using a screw conveyor. RO water was pressurized and heated up to the supercritical state using four electric heaters. Such water was first pumped to pre-heat the plant and reach the required operational conditions. Once the required operational conditions were achieved, the MDPF was fed via the extruder into the mixing piece where it was mixed with the supercritical water stream, to form a SCW-MDPF stream. After the mixing piece, the SCW-MDPF stream was further heated with heaters and fed into 4 HTT reactors in series, which were kept at a target temperature of 445° C. through the flow of hot combustion gases, in a chamber around the HTT reactors, the hot combustion gases being produced from a natural gas burner mixed with supplementary air to limit and control the temperature. Each HTT reactor was 6 m long and had a nominal diameter of 80 mm.

The HTT reactors were operated at an average temperature of 445° C. and an average pressure of 22.9 MPa, under pseudo-equilibrium flow conditions. Steady-state conditions, meaning that mass into the plant was equal to mass out of the plant and all the reactors were under pseudo-equilibrium flow conditions for the given set of plant parameters, were obtained after about one hour of operation at these conditions. The average flow was estimated about 35% by weight of MDPF and 65% of SCW (supercritical water). The average flowrate of MDPF was 15 kg/h.

After stopping the feeding of MDPF to the HTT reactors, additional water was passed through the SCW heaters to allow the plant to be flushed at process conditions for up to 1 h. The plant was then cooled by switching off the heaters, increasing the water flow rate, and depressurizing once the outlet temperature from the series of HTT reactors was less than 200° C.

The product stream exiting from HTT reactors was depressurized at full temperature and collected in a product tank. Such product stream spontaneously separated into a liquid product stream and process water, wherein about 1% of residual hydrocarbon product was estimated in the process water. The output of the test was a non-condensable gas product (gas product stream) and a liquid product stream; in addition and after the run, residual solid samples were recovered from the reactor tubes (solid product) in an amount corresponding to about 2% of the amount of dry MDPF fed during the run.

The liquid product stream represented about 71.2% of the amount of dry MDPF fed during the run. The liquid product was characterized via the ASTM D86 Standard Test Method for Distillation of Petroleum Products at Atmospheric Pressure (Table 1). The water content for the liquid product was determined to be 0.2% (by volume) via ASTM D95.

TABLE 1

ASTM D86 Standard Test Method for Distillation of Petroleum Products at Atmospheric Pressure of Liquid Product Stream

| Test | Result | Units |
|---|---|---|
| Instrument (Automatic or Manual) | Automatic | |
| Barometric Pressure | 760 | mm Hg |
| Initial Boiling Point | 59.1 | °C |
| 5% Evaporated | 103.5 | °C |
| 10% Evaporated | 122.9 | °C |
| 20% Evaporated | 151.6 | °C |
| 30% Evaporated | 180.7 | °C |
| 40% Evaporated | 215.2 | °C |
| 50% Evaporated | 251.2 | °C |
| 60% Evaporated | 291.2 | °C |
| 70% Evaporated | 332.0 | °C |
| 80% Evaporated | 369.6 | °C |
| 85% Evaporated | 378.7 | °C |

Gross calorific value (GCV) and net calorific value (NCV) of the liquid product were determined via DIN 51900-3:2005 and resulted to be respectively 45.6 and 42.5 MJ/kg.

Elemental analysis (carbon and hydrogen) of the liquid product stream was performed with ASTM D5291-16 (Method C). Nitrogen was determined via ASTM D4629-17, after filtration of the sample. Sulphur was determined via DIN EN ISO 20846:2018, after filtration of the sample.

Total Chlorine content was determined via DIN ISO 15597:2006. Results are reported in Table 2 below in weight% or ppm.

TABLE 2

Elemental Analysis of the Liquid Product Stream

| C, [wt%] | H, [wt%] | N, [ppm] | S, [ppm] | Cl, [ppm] |
|---|---|---|---|---|
| 85.5 | 14.4 | 59 | 7.4 | <5 |

ASTM D6730 (Detailed Hydrocarbon Analysis) for naphtha fraction of the liquid product is reported in Table 3, wherein the naphtha fraction is the fraction of the liquid product with a boiling point less than 175° C.

TABLE 3

ASTM D6730 (Detailed Hydrocarbon Analysis) for naphtha fraction

| Class Summary | Wt% | Vol% |
|---|---|---|
| n-Paraffins | 27.5 | 29.1 |
| Iso-Paraffins | 19.7 | 20.2 |
| Olefins | 18.2 | 18.7 |
| Naphthenes | 15.3 | 14.3 |
| Aromatics | 10.1 | 8.4 |
| Oxygenates | 0.000 | 0.000 |
| Unidentified | 9.3 | 9.4 |
| DHA Calculated Properties | | |
| Average Molecular Weight, [g/mol] | 107.5 | |
| Relative Density | 0.73 | |
| Octane Number | 66.0 | |

ASTM D7423 testing of naphtha fraction of the liquid product yielded a total oxygenates content of 330 ppm (Table 4 below).

TABLE 4

ASTM D7423 for the naphtha fraction

| Test | Result | Units |
|---|---|---|
| Dimethyl Ether | < 1.0 | ppm |
| Diethyl Ether | 1.0 | ppm |
| Acetaldehyde | 4.2 | ppm |
| ETBE | < 1.0 | ppm |
| MTBE | < 1.0 | ppm |
| DIPE | < 1.0 | ppm |
| Propionaldehyde | 1.2 | ppm |
| TAME | < 1.0 | ppm |
| Propyl Ether | 3.9 | ppm |
| Isobutylaldehyde | 23.9 | ppm |
| Butylaldehyde | 63.8 | ppm |
| Methanol | 5.9 | ppm |
| Acetone | < 1.0 | ppm |
| Isovaleraldehyde | 2.3 | ppm |
| Valeraldehyde | 168 | ppm |
| MEK | < 1.0 | ppm |
| Ethanol | 16.0 | ppm |
| NPA + IPA | 11.4 | ppm |
| Allyl Alcohol | 1.8 | ppm |
| IBA + TBA + SBA | 4.0 | ppm |
| n-Butanol | 22.9 | ppm |
| Total Oxygenates | 330.3 | ppm |

A naphtha fraction of liquid product, with the properties above, can be fed, directly or after treatment, to a steam cracker to produce ethylene and propylene, wherein the ethylene and propylene can be used to produce at least one diaper material, e.g. a PE nonwoven or PE backsheet film or PP nonwoven or alternatively the propylene can be used to produce acrylic acid, which is then used in the production of SAP. Other fractions of the liquid product, for example Distillate Gas Oil (DSO) having a boiling point between 175° C. and 350° C., and Heavy Gas Oil (HGO) having a boiling point between 350° C. and 550° C., can be used directly or after treatment to produce at least one diaper material, similarly to the naphtha fraction.

The gas product stream had an estimated density of 1.782 kg/m³, and its composition was determined on dry basis (values are expressed in vol%; Table 5 below).

TABLE 5

Composition of gas product stream (vol%)

| CO | CO₂ | H₂ | N₂ | O₂ | Argon | Methane | Ethane |
|---|---|---|---|---|---|---|---|
| 0.4 | 30 | 6.3 | 11 | 1.9 | <0.02 | 8.6 | 9.6 |
| Propane | Iso-Butane | n-Butane | Other C4s | Pentanes | Hexanes | Heptanes | Octanes |
| 8.9 | 1.4 | 2.9 | 4.7 | 5.6 | 1.8 | 0.32 | < 0.1 |

The gas product stream contaminants were determined on dry basis, values are expressed in ppm vol (Table 6 below).

TABLE 6

Contaminants in the gas product stream (ppm vol)

| Benzene | Toluene | Ethylbenzene | m- and p-xylenes | o-xylene | chlorobenzene | dichlorobenzene |
|---|---|---|---|---|---|---|
| 370 | 320 | 84 | 26 | 8.7 | <0.05 | <0.05 |
| trichlorobenzene | C3-benzene | naphthalene | Chlorinated compounds | Carbonyl sulfide | Hydrogen Sulfide | Carbon disulphide |
| < 0.05 | 14 | 0.55 | < 1.0 | 1.3 | < 0.5 | 0.61 |
| Methyl mercaptan | Ethyl mercaptan | Dimethyl sulfide | Dimethyl disulfide | Dimethyl trisulfide | | |
| < 0.1 | < 0.1 | 0.43 | 0.34 | < 0.1 | | |

The foregoing description is given for clearness of understanding only, and no unnecessary limitations should be understood therefrom, as modifications within the scope of the invention may be apparent to those having ordinary skill in the art.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, comprising any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An Absorbent Hygiene Product (AHP) comprising a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; wherein said used AHP stream is fed into a hydrothermal treatment (HTT) reactor operating at an HTT reactor temperature, at an HTT reactor pressure, and for an HTT reactor residence time; wherein said HTT reactor produces a liquid product stream, a gas product stream, and a solid product; wherein said liquid product stream comprises waste-derived fuel products; and wherein said waste-derived fuel products are converted to at least one of said PP, said PE, and said SAP.

2. The AHP of claim 1, wherein said HTT reactor temperature is higher than about 400° C.

3. The AHP of claim 1, wherein said HTT reactor pressure is higher than about 23 MPa.

4. The AHP of claim 1, wherein said HTT reactor residence time is longer than about 30 min.

5. The AHP of claim 1, wherein said used AHP stream comprises an aqueous solution.

6. The AHP of claim 5, wherein said aqueous solution is in supercritical conditions.

7. The AHP of claim 5, wherein said used AHP stream comprises between about 30% and about 80% said used AHP on a dry basis and between about 20% and about 70% said aqueous solution.

8. The AHP of claim 5, wherein said used AHP stream comprises between about 5% and about 25% used AHP on a dry basis, between about 35% and about 75% mixed plastic waste on a dry basis, and between about 20% and about 70% said aqueous solution.

9. The AHP of claim 1, wherein said waste-derived fuel products comprise n-paraffins, iso-paraffins, naphthenes, olefins, aromatics, or mixtures thereof.

10. The AHP of claim 9, wherein said waste-derived fuel products comprise n-paraffins and iso-paraffins between about 20% and about 50%; wherein said waste-derived fuel products comprise olefins between about 10% and about 20%; wherein said waste-derived fuel products comprise naphthenes between about 10% and about 20%; and wherein said waste-derived fuel products comprise aromatics between about 5% and about 20%.

11. The AHP of claim 1, wherein said waste-derived fuel products comprise naphtha.

12. The AHP of claim 1, wherein said waste-derived fuel products are treated to produce a stream suitable for feeding into a steam cracker.

13. The AHP of claim 10, wherein said waste-derived fuel products are fed into a steam cracker; and wherein said steam cracker produces a product stream comprising ethylene and propylene.

14. The AHP of claim 13, wherein said ethylene is converted to said PE; wherein part of said propylene is converted to said PP; and wherein part of said propylene is converted to said SAP.

15. The AHP of claim 14, wherein said AHP comprises at least one of said PE, said PP, and said SAP.

16. The AHP of claim 1, wherein said used AHP is size reduced to pieces; wherein said pieces are fed into an extruder to produce a melt stream; and wherein said melt stream is contacted with an aqueous solution to produce said used AHP stream.

17. The AHP of claim 16, wherein said size reduction is selected from the group comprising grinding, chipping, pelletization, granulation, flaking, powdering, shredding, milling, or compression and expansion.

18. The AHP of claim 17, wherein said used AHP pieces have an average size between about 0.1 mm and about 10 cm.

19. An Absorbent Hygiene Product (AHP) comprising a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from a used AHP stream comprising a used AHP; wherein said used AHP is size reduced to pieces; wherein said pieces have an average size between about 0.1 mm and about 10 cm; wherein said used AHP stream is fed into an extruder to produce a melt stream; wherein said melt stream is contacted with an aqueous solution to produce a mixed stream; wherein said mixed stream is fed into an HTT reactor operating at about 445° C., about 23 MPa, and for an HTT reactor residence time; wherein said HTT reactor produces a liquid product stream, a gas product stream, and a solid product; wherein said liquid product stream comprises waste-derived fuel products; wherein said waste-derived fuel products comprise n-paraffins, iso-paraffins, naphthenes, olefins, aromatics, or mixtures thereof; wherein said n-paraffins and said iso-paraffins comprise about 48% of said waste-derived fuel products, said naphthenes comprise about 15% of said waste-derived fuel products, said olefins comprise about 18% of said waste-derived fuel products, and said aromatics comprise about 10% of said waste-derived fuel products; wherein waste-derived fuel products comprise less than about 100 ppm nitrogen, less than about 100 ppm oxygen, less than about 5 ppm chlorine, less than about 0.001 ppm iron, less than about 0.125 ppm sodium, and less than about 0.5 ppm calcium; wherein said waste-derived fuel products are fed into a steam cracker; wherein said steam cracker produces a product stream comprising ethylene and propylene; wherein said ethylene is converted to said PE; wherein part of said propylene is converted to said PP; and wherein part of said propylene is converted to said SAP.

20. The AHP of claim 19, wherein said used AHP stream comprises about 25% said used AHP on a dry basis and about 75% mixed plastic waste on a dry basis.

21. A method of producing an Absorbent Hygiene Product (AHP) comprising:
a. providing a used AHP stream comprising a used AHP;
b. feeding said used AHP stream into a hydrothermal treatment (HTT) reactor operating at an HTT reactor temperature, at an HTT reactor pressure, and for an HTT reactor residence time; wherein said HTT reactor produces a liquid product stream, a gas product stream, and a solid product; wherein said liquid product stream comprises waste-derived fuel products;
c. converting said waste-derived fuel products to at least one of PP, PE, and SAP;
d. forming said AHP, wherein said AHP comprises a non-woven, a backsheet film, and a superabsorbent polymer (SAP); wherein said non-woven comprises polypropylene (PP); wherein said backsheet film comprises polyethylene (PE); wherein said SAP comprises poly(acrylic acid) produced from propylene; wherein at least one of said PP, said PE, and said SAP are produced from the used AHP stream.
